(19) United States
(12) Patent Application Publication
(10) Pub. No.: US 2014/0002352 A1
(43) Pub. Date: Jan. 2, 2014

(54) EYE TRACKING BASED SELECTIVE ACCENTUATION OF PORTIONS OF A DISPLAY

(71) Applicants: Michal Jacob, Haifa (IL); Barak Hurwitz, Kibbutz Alonim (IL); Gila Kamhi, Zichron Yaakov (IL)

(72) Inventors: Michal Jacob, Haifa (IL); Barak Hurwitz, Kibbutz Alonim (IL); Gila Kamhi, Zichron Yaakov (IL)

(21) Appl. No.: 13/977,519

(22) PCT Filed: May 9, 2012
(86) PCT No.: PCT/US12/37017

§ 371 Date: Jun. 28, 2013

(51) Int. Cl. G06F 3/01

(52) U.S. Cl. CPC G06F 3/013
USPC 345/156

(57) ABSTRACT

Systems, apparatus, articles, and methods are described including operations for eye tracking based selective accentuation of portions of a display.

### BACKGROUND

Training materials are often utilized for wide adoption of applications of all sorts. Accordingly, enterprises are often interested in methods for creation of training material including online demos and/or presentations that effectively record the training session. On-demand interactive training and support videos are often used for rolling out new software, orienting new staff, showing customers how to use your product, or establishing a “self-help” desk. One may be able to record a live presentation or lecture and give students a rewind button for class and help them learn at their own pace or catch up from an absence. In other implementations, a presenter and an observer might both be viewing the same display at the same time.

Software that facilitates the effective recording of a presentation, demo or training has several of benefits. Such training/demo recording software may be used as a means for efficient ramp-up and training on software packages and applications. The trainee can observe the training material offline at his/her own pace and may focus on specific areas of his/her interest. Moreover, such training/demo recording software may be utilized for the delivery of a training session to a wide audience; since the training delivery need not be constrained by the availability of trainer or the trainee.

Today's training/demo recording software, such as Microsoft® LiveMeeting, Camtasia® Recorder, or the like, may record the full or customized section of the screen including the speech of the trainer. The actual training session at the time of delivery or off-line by trainer can be captured/recorded and then edited and posted for public usage. Additionally, much of the recording software (e.g., Camtasia® Recorder) may provide the ability to capture a training session with special effects in order to record a session that provides the user the experience of online training by an expert presenter. In some cases, the software may utilize speech recognition technologies to automatically generate captions that can be later modified or fixed by the trainer. In addition to audio, mouse clicks also may be used for special effects (e.g., focus or zoom on areas of interest). Accordingly, training/demo recording software may provide focus (by determining to which region of the screen to zoom-in/zoom-out based on mouse clicks).

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example selective accentuation system;

FIG. 2 is a flow chart illustrating an example selective accentuation process;

FIG. 3 is an illustrative diagram of an example selective accentuation system in operation;

FIG. 4 is an illustrative diagram of an example selective accentuation system;

FIG. 5 is an illustrative diagram of an example system; and

FIG. 6 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

Systems, apparatus, articles, and methods are described below including operations for selectively accentuating portions of a display based at least in part on eye tracking.

As described above, in some cases, training/demo recording software may utilize mouse clicks for generating special effects (e.g., focus or zoom on areas of interest). Accordingly, training/demo recording software may provide focus (by determining to Which region of the screen to zoom-in/zoom-out based on mouse clicks). However, automatic focus based on cursor location or mouse clicks (also referred to as Smart Focus) may not necessarily provide the right focus since during the delivery of a presentation or demonstration of a tool, the cursor may not necessarily point to the area of focus. Moreover, in the case that the output (training recording) is fine-tuned via trainer's explicit clicks, the recording will include the redundant display of cursor that can be annoying to the trainee.

As will be described in greater detail below, operations for selectively accentuating portions of a display may utilize eye gaze tracking for implicit and accurate identification of the area of interest for accentuation. In other words, the user gaze may implicitly controls the accentuation; thus, naturally accentuating only the area on the screen that the user is intentionally looking at (e.g., the main area of the user's focus as opposed to an area that the user glances at momentarily, unconsciously or involuntarily). Usage of such gaze information is a more accurate means to determine the user activity in front of the computer than other conventional means (i.e., keyboard or mouse clicks). Additionally, user gaze information may provide a more natural and user-friendly means for implementing operations for selectively accentuating portions of a display.

For example, operations for selectively accentuating portions of a display may determine which areas on the screen to give focus (e.g., zoom-in/out) via a trainer's gaze instead of mouse clicks. Gaze may be a more natural way to follow the trainer and provide a recording with the most natural effective user (trainee) experience. In case of screen captures via self-recording of the trainer, the focus that needs to be put on the presentation or demo can be naturally driven by the gaze of the trainer assuming that the trainer looks primarily where the focus of the trainee needs to be (e.g., to an important region where the trainer intends the trainee to focus on). Accordingly, eye tracking may be utilized for implicit and accurate identification of the area of interest during recording of a product demo, sales presentation, or for alternatively adding the focus effect to a screen recording via editing the recording (again using eye tracking).

Similarly, in a scenario in which two people are sitting in front of the same computer, observing the same display, the trainer may show the trainee how to use an application, review of a document, a website, or the like. In this situation, the display may be diverse and full of detailed information. For the trainer, it is very obvious what the area of interest is, and where in the display resides the relevant information. The trainee, however, does not share that knowledge. The display may be crowded with information; therefore detecting the relevant spots to which the trainer aims may not be obvious to the trainee unless the trainer explicitly points them out. This situation may typically be ameliorated by the trainer physically pointing with a finger or by using the mouse. However, physically pointing is time-consuming, effort demanding and often not accurate enough. Similarly, mouse pointing may not be fast and may not necessarily provide the right focus since during the delivery of a presentation or demonstration of a tool, the cursor may not necessarily point to the area of focus.

Accordingly, as will be described in greater detail below, operations for selectively accentuating portions of a display that utilize eye tracking may also be applied to live presentations where the trainer and trainee are simultaneously looking at the same displayed material. For example, eye tracking may be utilizes as a natural way of pointing to the region of interest by highlighting the gaze spots, which may indicate the exact informative regions to which the trainer is aiming. Such eye tracking based highlighting may guide the trainee to the desired screen location, and may makes following the trainer more intuitive. For this purpose, the trainer's eye fixations may be tracked. Accordingly, instead of scanning the entire document, the trainee may be immediately directed to the correct spot, by selectively accentuating portions of a display based on eye tracking of the trainer. Further, such eye tracking based highlighting may free the mouse and permits the mouse to be used separately, a-synchronically from eye tracking based highlighting. Note that when simultaneously sitting in front of the computer display, the trainer and trainee can also switch roles occasionally, or the observed regions of both of them can be highlighted simultaneously (e.g. in different colors), for example.

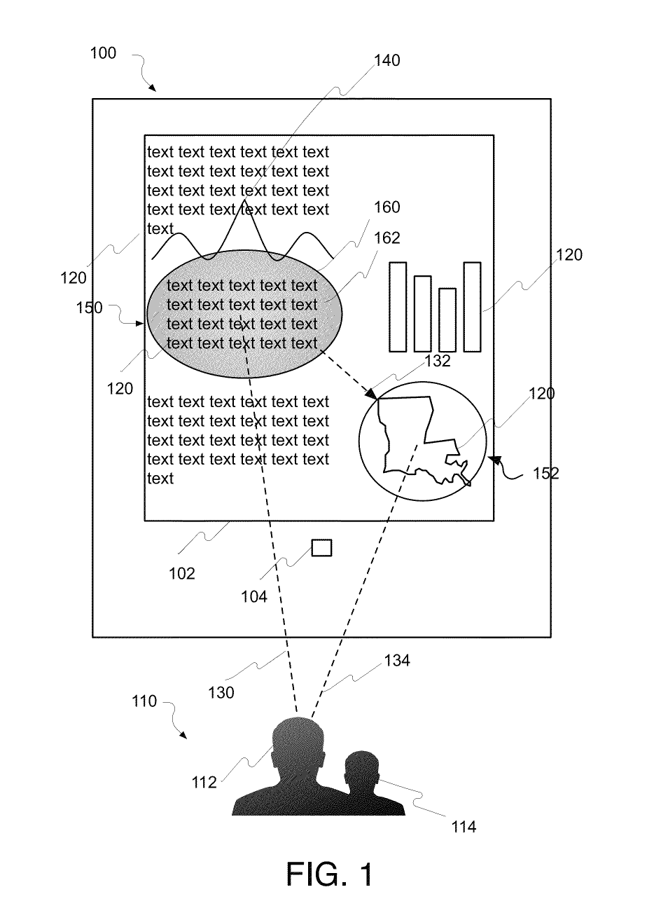

FIG. 1 is an illustrative diagram of an example selective accentuation system 100, arranged in accordance with at least some implementations of the present disclosure. In the illustrated implementation, selective accentuation system 100 may include a display 102 and an imaging device 104. In some examples, selective accentuation system 100 may include additional items that have not been shown in FIG. 1 for the sake of clarity. For example, selective accentuation system 100 may include a processor, a radio frequency-type (RF) transceiver, and/or an antenna. Further, selective accentuation system 100 may include additional items such as a speaker, a microphone, an accelerometer, memory, a router, network interface logic, etc, that have not been shown in FIG. 1 for the sake of clarity.

Imaging device 104 may be configured to capture eye movement data from one or more users 110 of selective accentuation system 100. For example, imaging device 104 may be configured to capture eye movement data from a first user 112, a second user 114, from one or more additional users, the like, and/or combinations thereof. In some examples, imaging device 104 may be located on selective accentuation system 100 so as to be capable of viewing users 110 while users 110 are viewing display 102.

In some examples, eye movement data of the first user may be captured via a camera sensor-type imaging device 104 or the like (e.g., a complementary metal-oxide-semiconductor-type image sensor (CMOS), a charge-coupled device-type image sensor (CCD), Infra-Red Light Emitting Diodes (IR-LEDs) and an IR-type camera sensor, and/or the like), without the use of a red-green-blue (RGB) depth camera and/or microphone-array to locate who is speaking. In other examples, an RGB-Depth camera and/or microphone-array might be used in addition to or in the alternative to the camera sensor. In some examples, imaging device 104 may he provided via either a peripheral eye tracking camera or as an integrated a peripheral eye tracking camera in selective accentuation system 100.

In operation, selective accentuation system 100 may utilize eye movement data inputs to be capable of determining which portions of display 102 to selectively accentuate. Accordingly, selective accentuation system 100 may be capable of performing selective accentuation by leveraging visual information processing techniques. For example, selective accentuation system 100 may receive eye movement data from imaging device 104 from one or more users 110. A determination may be made regarding which portions of display 102 to selectively accentuate based at least in part on the received eye movement data.

In some examples, such eye tracking may include tracking fixations 130 and/or gazes. As used herein the term “gaze” may refer to gaze points that may be samples given by the eye tracker at a certain frequency, while fixations may be observation of a certain point for an amount of time, inferred from the gaze data.

Fixations 130 may refer to observations of a certain point in the visual field. This input, spanning about two degrees of the visual field, is processed by the human brain with sharpness, clarity and accuracy (e.g., with accuracy as compared relatively to peripheral vision). There are typically about three to four fixations 130 per second, with a duration of about two hundred to three hundred milliseconds each. For example, fixation 130 may include several closely grouped gaze points (sampled for instance in frequency of 60 Hz, that is, once every ˜16.7 milliseconds).

Saccades 132 may refer to a relocation of the point of fixation. Saccades 132 may be fast ballistic movements (e.g., the target is decided before initiation) between a first fixation 130 and a second fixation 134. Saccades 132 typically have an amplitude of up to about twenty degrees and a duration of about forty milliseconds (during which there is a suppression of the visual stimulus).

Fixations 130/134 and/or saccades 132 may be utilized for gathering and integrating visual information. Fixations 130/134 and/or saccades 132 may also reflect the intentions and cognitive states of one or more users 110.

In some examples, eye tracking may be performed for at least one of the one or more users 110. For example, the eye tracking may be performed based at least in part on the received eye movement data 130. A region of interest 140 may be determined, where the region of interest may be associated with a portion of display 102 of the selective accentuation system 100. For example, the determination of the region of interest 140 may be based at least in part on the performed eye tracking.

In some examples, such selective accentuation may include selectively accentuating an area of display 102 based at least in part on associating region of interest 140 with a discrete display element 120. As used herein the term “discrete display element” may refer to an identifiable and separate item being displayed. For example, discrete display element 120 may include a text box, a paragraph of text, a default number of text lines, a picture, a menu, the like, and/or combinations thereof. As illustrated, discrete display elements 120 might include several paragraphs of text and/or several pictures. For example, gaze duration on a display element 120 may be determined. Such gaze duration may be based on a determination of the proportion of time spent looking at a given display element 120. Alternatively, the determined region of interest 140 may not be associated with any particular discrete display element 120. In such an example, region of interest 140 may be defined with a default shape and/or proportion, such as a default rectangular, oval or other shape.

The portion (e.g., a focus area 150) of display 102 associated with the determined region of interest 140 may be selectively accentuated. In some examples, selective accentuation system 100 may operate so that the selective accentuation includes selectively accentuating focus area 150 corresponding with region of interest 140 based at least in part on associating region of interest 140 with a discrete display element 120. Additionally or alternatively, selective accentuation system 100 may operate so that the selective accentuation may include selectively accentuating focus area 150 corresponding with region of interest 140 based at least in part on a default area size that may be centered on the region of interest 140. For example, focus area 150 corresponding with region of interest 140 might have a default shape and proportion, such as a default rectangular, oval or other shape.

Additionally or alternatively, selective accentuation system 100 may operate so that the selective accentuation includes selectively accentuating a second focus area 152. For example, second focus area 152 may correspond with the portion of display 102 associated with a second determined region of interest. Additionally or alternatively, the selective accentuation may include graphically illustrating a transition (as might be illustrated by saccade 134) between focus area 150 and second focus area 152. The selective accentuation may include removing the selective accentuation of focus area 150 in response to a determination that a current region of interest is located off of display 102. In some examples, two regions (e.g., focus area 150 and second focus area 152) may be determined as focus areas even if no direct saccade between them was conducted. Several areas (more than two) may be accentuated concurrently, if they are determined to be in the focus over time. Graphically illustrating the transition between one set of focused areas to another set of focused areas may be done by illustrating the change in the combination of the accentuated focus areas.

The selective accentuation may include one or more of the following accentuation techniques: zooming in on focus area 150, out scaling (e.g., superimposing an enlarged focus area 150 so as to appear above the underlying image) focus area 150, highlighting focus area 150. For example, highlighting the focus area may include framing focus area 150 (e.g., via a frame 160), re-coloring focus area 150 (e.g., via a coloring 162), framing and re-coloring focus area 150, the like, and/or combinations thereof.

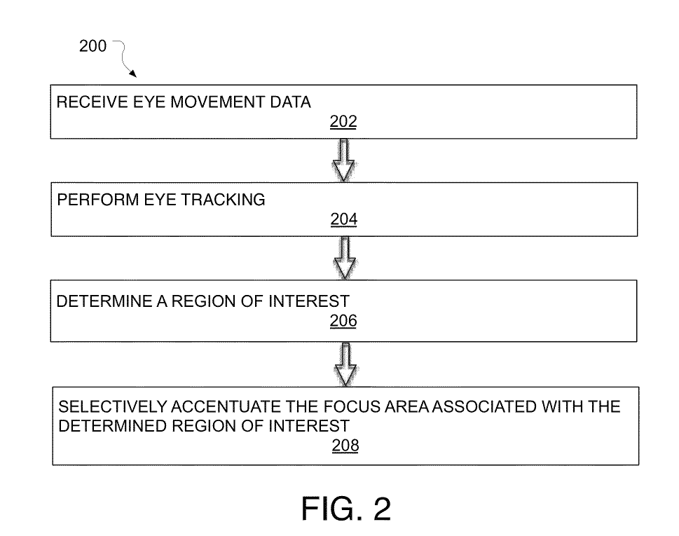

As will be discussed in greater detail below, selective accentuation system 100 may be used to perform some or all of the various functions discussed below in connection with FIGS. 2 and/or 3.

FIG. 2 is a flow chart illustrating an example selective accentuation process 200, arranged in accordance with at least some implementations of the present disclosure. In the illustrated implementation, process 200 may include one or more operations, functions or actions as illustrated by one or more of blocks 202, 204, 206, and/or 208. By way of non-limiting example, process 200 will be described herein with reference to example selective accentuation system 100 of FIGS. 1 and/or 4.

Process 200 may begin at block 202, “RECEIVE EYE MOVEMENT DATA”, where eye movement data may be received. For example, the received eye movement data may be captured via a CMOS-type image sensor, a CCD-type image sensor, an RGB-Depth camera, an IR-type imaging sensor with IR-LEDs, and/or the like.

Processing may continue from operation 202 to operation 204, “PERFORM EYE TRACKING”, where eye tracking may be performed. For example, eye tracking may be performed for at least one of the one or more users based at least in part on the received eye movement data.

In some examples, such eye tracking may include gaze point samples, from which fixations, saccades, and other eye movement types can be inferred. For example, gaze duration on a display element (e.g., word, sentence, specific column/row at a text area, and/or image) may be determined For example, such gaze duration may be based on a determination of the proportion of time spent looking at a given display element.

In another example, such analysis of the eye movement data may include determining the number of fixations on the area of interest for a given time window (e.g., the last minute), in relation to a given display element. For example, such fixations may illustrate the proportion of interest on the area of interest of the display element (e.g., word, sentence, specific column/row at a text area, and/or image) as compared to other areas in the text or display area. This metric may indicate the “importance” of the area to the viewer and may be directly related to a gaze rate.

In a further example, such eye tracking may include determining the number of gazes on the area of interest for a given time window. Gaze may be referred to as a continuous observation of a region, consisted of successive fixations. Therefore the number of gazes on an area of interest in a certain time window would refer to the number of returns to that area. For example, such a determination of the number of returns may illustrate the proportion of observation of the area of interest of a display element as compared to other areas in the text or display area. The number of gazes can be measured as the number of return saccades to the area of interest (defining a display or text element) and provide an indication (e.g., as only one example among many possible indications) of the importance of the display item to a user, and may be used to trigger selective accentuation.

Processing may continue from operation 204 to operation 206, “DETERMINE A REGION OF INTEREST”, where a region of interest may be determined following analysis of the eye movement data. For example, the region of interest associated with a portion of the display of the computer system based at least in part on the performed eye tracking

Processing may continue from operation 206 to operation 208, “SELECTIVELY ACCENTUATE THE FOCUS AREA ASSOCIATED WITH THE DETERMINED REGION OF INTEREST”, where the focus area associated with the determined region of interest may be selectively accentuated. For example, the focus area that corresponds with the portion of the display associated with the determined region of interest may be selectively accentuated.

In operation, process 200 may utilize smart and context aware responses to user visual queues. For example, process 200 may be capable of telling where a user's attention is focused to responsively selectively accentuate only portions of a given display.

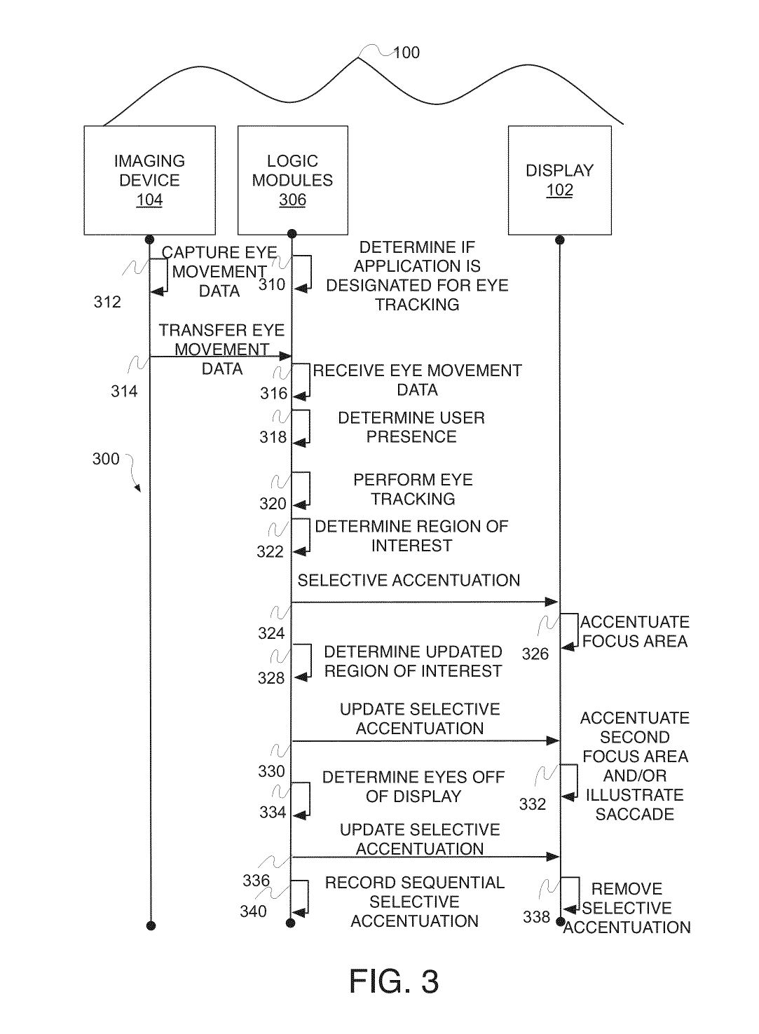

Some additional and/or alternative details related to process 200 may be illustrated in one or more examples of implementations discussed in greater detail below with regard to FIG. 3.

FIG. 3 is an illustrative diagram of example selective accentuation system 100 and selective accentuation process 300 in operation, arranged in accordance with at least some implementations of the present disclosure. In the illustrated implementation, process 300 may include one or more operations, functions or actions as illustrated by one or more of actions 310, 311, 312, 314, 316, 318, 320, 322, 324, 326, 328, 330, 332, 334, 336, 338 and/or 340. By way of non-limiting example, process 300 will be described herein with reference to example selective accentuation system 100 of FIGS. 1 and/or 4.

In the illustrated implementation, selective accentuation system 100 may include display 102, imaging device 104, logic modules 306, the like, and/or combinations thereof

Although selective accentuation system 100, as shown in FIG. 3, may include one particular set of blocks or actions associated with particular modules, these blocks or actions may be associated with different modules than the particular module illustrated here.

Process 300 may begin at block 310, “DETERMINE IF APPLICATION IS DESIGNATED FOR EYE TRACKING”, where a determination may be made as to whether a given application has been designated for eye tracking. For example, an application currently being presented on display 102 may or may not have been designated for operation with eye tracking based selective accentuation.

In some examples, given applications may have a default mode e.g., eye tracking on or eye tracking oft) that will enable the feature for all the applications, some categories of applications (e.g., text based applications may be defaulted to having eye tracking on while video based applications may be defaulted to haying eye tracking off), or an application-by-application basis. Additionally or alternatively, user selection may be utilized to enable or disable the feature for all the applications, some categories of applications, or an application-by-application basis. For example, a user may be prompted to enable or disable the feature,

Processing may continue from operation 310 to operation 312, “CAPTURE EYE MOVEMENT DATA”, where eye movement data may be captured. For example, capturing of eye movement data may be performed via imaging device 104. In some examples, such capturing of eye movement data may he performed in response to a determination at operation 310 that application currently being presented on display 102 has been designated for operation with eye tracking based selective accentuation.

Processing may continue from operation 312 to operation 314, “TRANSFER EYE MOVEMENT DATA”, where eye movement data may he transferred. For example, eye movement data may be transferred from imaging device 104 to logic modules 306.

Processing may continue from operation 314 to operation 316, “RECEIVE EYE MOVEMENT DATA”, where eye movement data may be received. For example, the received eye movement data may be captured via a CMOS-type image sensor, a CCD-type image sensor, an RGB-Depth camera, an IR-type imaging sensor with IR-LEDs, and/or the like.

Processing may continue from operation 316 to operation 318, “DETERMINE USER PRESENCE”, where the presence or non-presence of a user may be determined. For example, a determination may be made whether at least one of the one or more users is present based at least in part on the received eye movement data, where the determination of whether at least one of the one or more users is present occurs in response to the determination at operation 310 that the application has been designated for operation with eye tracking.

For example, process 300 may include facial detection, where a face of user may be detected. For example, the face of the one or more users may he detected, based at least in part on eye movement data. In some examples, such face detection (e.g., which may optionally include facial recognition) may be configured to differentiate between the one or more users. Alternatively or additionally, differences in eye movement patterns may be used to differentiate between two or more users. Such facial detection techniques may allow relative accumulations to include face detection, eve tracking, landmark detection, face alignment, smile/blink/gender/age detection, face recognition, detecting two or more faces, and/or the like.

Processing may continue from operation 316 and/or 318 to operation 320, “PERFORM EYE TRACKING”, where eye tracking may be performed. For example, eye tracking may be performed for at least one of the one or inure users based at least in part on the received eye movement data. For example, the performance of eye tracking may occur in response to the determination at operation 318 that at least one of the one or more users is present, for at least one of the one or more users. Additionally, or alternatively, the performance of eye tracking may occur in response to the determination at operation 310 that the application has been designated for operation with eye tracking.

Processing may continue from operation 320 to operation 322, “DETERMINE A REGION OF INTEREST”, where a region of interest may be determined For example, the region of interest associated with a portion of the display of the computer system may be based at least in part on the performed eye tracking.

Processing may continue from operation 322 to operation 324, “SELECTIVE ACCENTUATION”, where the focus area associated with the determined region of interest may be selectively accentuated. For example, the focus area that corresponds with the portion of the display associated with the determined region of interest may be selectively accentuated.

In some examples, process 300 may operate so that a focus area may be determined based on a vicinity defined by a given radius centered at the location of the gaze, a predefined number of lines up and down from a central gaze location, a certain percentage area of the total display from a central gaze location, an entire paragraph of text, and entire image, or the like. In other examples, process 300 may operate so that a focus area may be determined based at least in part on sizing the focus area to accommodate a discrete display element, where the discrete display element may include a text box, a paragraph of text, a default number of text lines, a picture, a menu, the like, and/or combinations thereof.

In some examples, process 300 may operate so that the selective accentuation of the focus area includes one or more of the following accentuation techniques: zooming in on the focus area, out scaling the focus area, highlighting the focus area, the like, and/or combinations thereof. For example, the highlighting the focus area may include framing the focus area, re-coloring the focus area, framing and re-coloring the focus area, and/or the like.

Processing may continue from operation 324 to operation 326, “ACCENTUATE FOCUS AREA”, where display 102 may accentuate the focus area portion of display 102. For example, the selective accentuation may include selectively accentuating an area based at least in part on a default area size. Additionally or alternatively, the selective accentuation may include selectively accentuating an area based at least in part on associating the region of interest with a discrete display element.

Processing may continue from operation 326 to operation 328, “DETERMINE UPDATED REGION OF INTEREST”, where an updated region of interest may be determined. For example, the updated region of interest associated with a portion of the display of the computer system may be based at least in part on the changes in a users gaze as may be indicated by continuing performed eye tracking. For example, such an updated region of interest may be determined when the user's eyes change to a new fixation, or as a consequence of a sequence of fixations of the user.

Processing may continue from operation 328 to operation 330, “UPDATE SELECTIVE ACCENTUATION”, where a second focus area associated with the updated determined region of interest may be selectively accentuated. For example, the second focus area that corresponds with the portion of the display associated with the determined updated region of interest may be selectively accentuated. In some examples, one or more subsequent focus areas may be sequentially accentuated.

Processing may continue from operation 330 to operation 332, “ACCENTUATE SECOND FOCUS AREA AND/OR ILLUSTRATE TRANSITION”, where display 102 may present an accentuated second focus area and/or a transition (e.g., a saccade from a first focus area to the second focus area). For example, the second focus area corresponding with the portion of the display associated with the updated determined region of interest may be selectively accentuated via display 102. Additionally or alternatively, the transition between the focus area and the one or more subsequent focus areas may be graphically illustrated via display 102.

Alternatively, each fixation may be shown only when it occurs, just one at a time, and the highlighted focus area may change according to the timeline. For example, the fixations can either be shown consecutively, or continuous path of fixations can be shown, composed of fixations connected to the preceding ones in the order of appearance (for example a path of fixations by themselves or a path of fixations connected by saccades). In some examples, the saccades can be traced separately from the focus areas, as there is no need to necessarily show the saccades in relation to the accentuated focus areas (as the fixations do not have to be shown). Also, in some examples as mentioned above, there does not have to be a direct saccade between multiple focus areas (i.e., there might be an intermediate fixation elsewhere).

As will be discussed in greater detail below, a recording of accentuated focus areas and/or a transitions may permit a replay of the sequence of fixations of a user in a desired speed, in order to review the information or stages of an action (e.g., finding a relevant field in an inner menu) offline. Accordingly, a trainee might have the opportunity to review the demonstration by himself/herself, as many times and in the exact pace that is wished. Moreover, the speed of the replay can be adjusted, to slowly repeat a demonstration, for instance.

Processing may continue from operation 332 to operation 331, “DETERMINE EYES OFF OF DISPLAY”, where a determination may be made that the user's eyes are no longer on the display and/or on the active application. For example, a determination may be made that the user's eyes are no longer on the display and/or on the active application based at least in part on the changes in a users gaze as may be indicated by continuing performed eye tracking. For example, recognition that the user's eyes are no longer on the display and/or on the active application may be determined when the users eyes change to a new fixation.

In some examples, accentuation effects may be removed in cases Where the user's gaze is not on the focus area (e.g., a lack of gaze dwell time on the focus area), or in other words, when it is not the focus area anymore. This step may ensure that the application does not accentuate unnecessarily. For example, accentuation effects may be removed in cases Where the proportion of the user's gaze on a former focused area is small; or When the user's gaze is not observed on the display for a period of time (where a “no-gaze-on-display” period threshold may be determined by system configuration).

Processing may continue from operation 334 to operation 336, “UPDATE SELECTIVE ACCENTUATION”, where an updated selective accentuation may be determined. For example, an updated selective accentuation may be sent to display 102 where a determination has been made that the user's eyes are no longer on the display and/or on the active application.

Processing may continue from operation 336 to operation 338, “REMOVE SELECTIVE ACCENTUATION”, where any selective accentuation may be removed from display 102. For example, any selective accentuation may be removed from display 102 in response to a determination that a current region of interest is located off of the display and/or off of the active application. Additionally or alternatively, selective accentuation of the focus area may be removed from display 102 in response to a determination that there has been a change from the focus area to the second focus area (e.g., when the focus area is not in focus anymore and a subsequent focus area has not been established).

Processing may continue from operation 338 to operation 340, “RECORD SEQUENTIAL SELECTIVE ACCENTUATION”, where any selective accentuation may be recorded. For example, a recording of the sequential selective accentuation of the focus area, the transition between the focus area and the second focus area, and the selective accentuation of the second focus area may be made. Additionally or alternatively, such a recording may record other aspects of a presentation, such as audio data of the voice of the user, visual data of the face of the user, the changing appearance of display 102, the like, and/or combinations thereof. For example, recording operation 340 may record the user's voice, the user's eye movements, and the display images, in synchronization, during the observation and guidance process. The recorded data may serve later on to dynamically present and highlight the trace of fixations, superimposed on the display content. for example.

In some examples, recording operation 340 may be on any time that a determination has been that an active application has been designated for eye tracking based selective accentuation. Additionally or alternatively, recording operation 340 may be selectively turned on or off, such as via a prompt for a user to indicate whether recoding should be done or not.

In some examples, such recoding may capture on-line training sessions (e.g., training sessions integrated into tele-presence and/or phone-meeting software, such as Microsoft® LiveMeeting or specialized software (e.g., Camtasia™)) during the delivery of an actual presentation session. In other examples, such recoding may capture off-line training sessions, such as where the trainer previously prepares a recording offline utilizing specialized software. In both cases process 300 may permit the trainer to edit and/or modify and post process such a recording.

In operation, process 300 may determine which applications will be registered to perform with eye tracking. Process 300 may determine an area to be selectively accentuated by tracking a user's gaze when eye tracking is “on” for an active application (e.g., an application that is on the foreground of the system 100) and/or it is determined that a user is present. Process 300 may compute gaze data (e.g., x,y coordinates of gaze on display 102 and an associated time stamp of the gaze). In cases where the x,y coordinates of the gaze are outside the region of the displayed application, any selective accentuation effect may be removed from display 102.

In some implementations, eye movements of a user may be tracked and recorded when the eye tracking mode is activated. An eye tracking based accentuation (e.g., a zoom-in smart focus effect) may be configured via several pre-defined control parameters provided by software screen capture/recording applications (e.g., accentuation scale, accentuation duration, fixation parameters, saccade parameters, and/or the like). For example, a zoom-in/out-type accentuation may be based on preset system thresholds for scale. Additionally or alternatively, such a zoom-in/out-type accentuation may be based on preset system thresholds for duration. During an on-line/off-line presentation/demo recording, a determination may be made of the area of focus based on the user's gaze on display 102.

In other implementations, in a scenario in which two people are sitting in front of the same computer, observing the same display, a trainer may show a trainee how to use an application, review of a document, a website, or the like. In this situation, a first and second user might switch roles between them as to who is in control of the eye tracking output. For example, two or more users can switch roles between them, using a switching mode, allowing alteration of the eye tracking between two people. On the practical side, the eye-tracker can be calibrated in advance for both people—this is possible since when two people sit aside, their heads are typically a large enough distance from one another. Some eye-tracker solutions may use a head-tracking mechanism, allowing the following of the eyes of a selected person.

While implementation of example processes 200 and 300, as illustrated in FIGS. 2 and 3, may include the undertaking of all blocks shown in the order illustrated, the present disclosure is not limited in this regard and, in various examples, implementation of processes 200 and 300 may include the undertaking only a subset of the blocks shown and/or in a different order than illustrated.

In addition, any one or more of the blocks of FIGS. 2 and 3 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 2 and 3 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

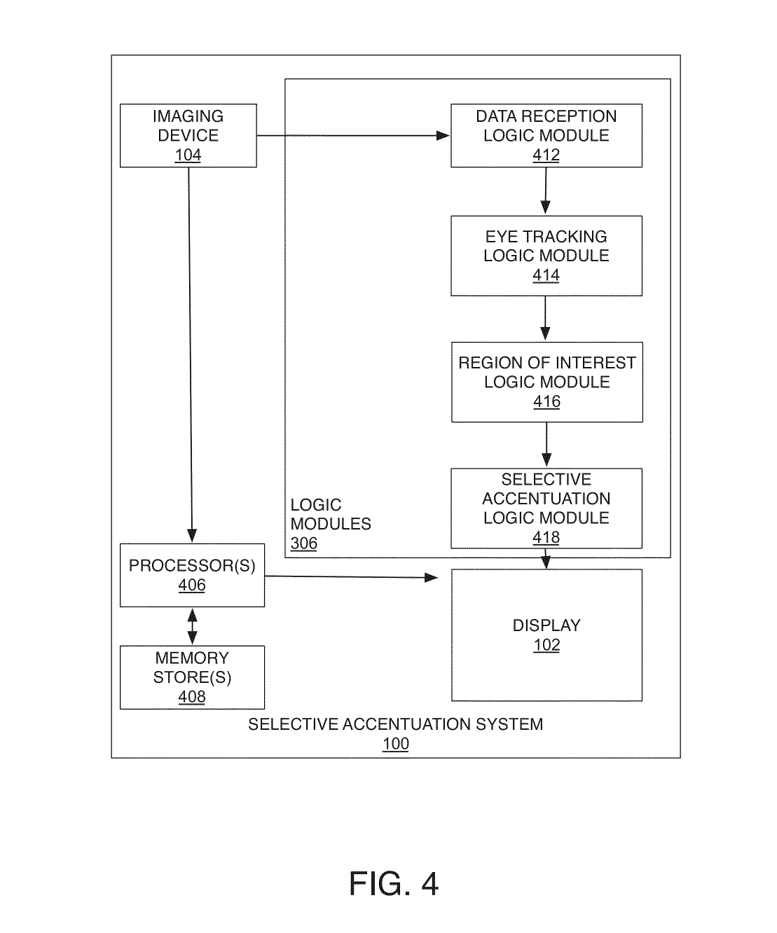

FIG. 4 is an illustrative diagram of an example selective accentuation system 100, arranged in accordance with at least some implementations of the present disclosure. In the illustrated implementation, selective accentuation system 100 may include display 102, imaging device 104, and/or logic modules 306. Logic modules 306 may include a eye movement data logic module 412, an eye tracking logic module 414, a region of interest logic module 416, a selective accentuation logic module 418, the like, and/or combinations thereof. As illustrated, display 102, imaging device 104, processor 402 and/or memory store 404 may be capable of communication with one another and/or communication with portions of logic modules 306. Although selective accentuation system 100, as shown in FIG. 4, may include one particular set of blocks or actions associated with particular modules, these blocks or actions may be associated with different modules than the particular module illustrated here.

In some examples, imaging device 104 may be configured to capture eye movement data. Processors 402 may be communicatively coupled to display 102 and to imaging device 104. Memory stores 404 may be communicatively coupled to processors 402. Data reception logic module 412, eye tracking logic module 414, region of interest logic module 416, and/or selective accentuation logic module 418 may be communicatively coupled to processors 402 and/or memory stores 404.

In some examples, data reception logic module 412 may be configured to receive eye movement data of one or more users. Eye tracking logic module 414 may be configured to perform eye tracking for at least one of the one or more users based at least in part on the received eye movement data. Region of interest logic module 416 may be configured to determine a region of interest associated with a portion of display 102 based at least in part on the performed eye tracking. Selective accentuation logic module 418 may be configured to selectively accentuate the focus area, where the focus area corresponds with the portion of the display 102 associated with the determined region of interest.

In some examples, logic modules 306 may include a recording logic module (not shown), which may be coupled to processors 406 and/or memory stores 408. The recording logic module may be configured to record the sequential selective accentuation of the focus area, the transition between the focus area and the second focus area, the selective accentuation of the second focus area, and/or the like. Additionally or alternatively, the recording logic module may be configured to record other aspects of a presentation, such as audio data of the voice of the user, visual data of the face of the user, the changing appearance of display 102, the like, and/or combinations thereof.

In various embodiments, selective accentuation logic module 418 may be implemented in hardware, while software may implement data reception logic module 412, eye tracking logic module 414, region of interest logic module 416, and/or recording logic module (not shown). For example, in some embodiments, selective accentuation logic module 418 may be implemented by ASIC logic while data reception logic module 412, eye tracking logic module 414, region of interest logic module 416, and/or recording logic module may be provided by software instructions executed by logic such as processors 406. However, the present disclosure is not limited in this regard and eye tracking logic module 414, region of interest logic module 416, selective accentuation logic module 418, and/or recording logic module may be implemented by any combination of hardware, firmware and/or software. In addition, memory stores 408 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 408 may be implemented by cache memory.

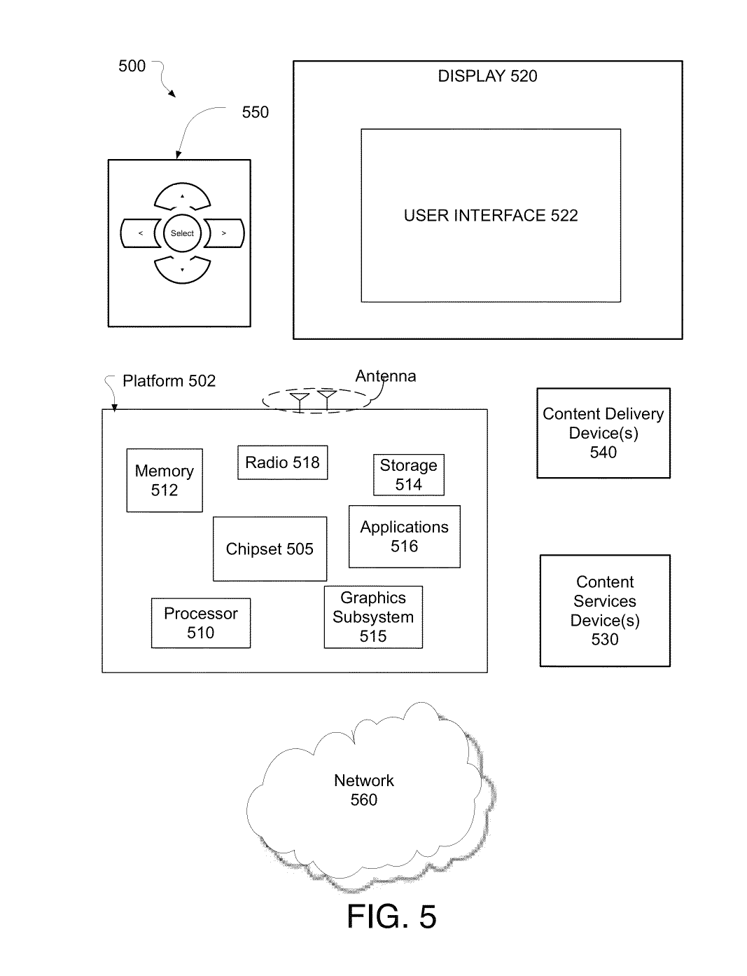

FIG. 5 illustrates an example system 500 in accordance with the present disclosure. In various implementations, system 500 may be a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internee device (MID), messaging device, data communication device, and so forth.

In various implementations, system 500 includes a platform 502 coupled to a display 520. Platform 502 may receive content from a content device such as content services device(s) 530 or content delivery device(s) 540 or other similar content sources. A navigation controller 55( )including one or more navigation features may be used to interact with, for example, platform 502 and/or display 520. Each of these components is described in greater detail below.

In various implementations, platform 502 may include any combination of a chipset 505, processor 510, memory 512, storage 514, graphics subsystem 515, applications 516 and/or radio 518. Chipset 505 may provide intercommunication among processor 510, memory 512, storage 514, graphics subsystem 515, applications 516 and/or radio 518. For example, chipset 505 may include a storage adapter (not depicted) capable of providing intercommunication with storage 514.

Processor 510 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 510 may be dual-core processor(s), dual-core mobile processor(s), and so forth.

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 514 may include technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (WU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 may be integrated into processor 510 or chipset 505. In some implementations, graphics subsystem 515 may be a stand-alone card communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 518 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 518 may operate in accordance with one or more applicable standards in any version.

In various implementations, display 520 may include any television type monitor or display. Display 520 may include, for example, a computer display screen, touch screen display, video monitor, television-like device, and/or a television. Display 520 may be digital and/or analog. In various implementations, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In various implementations, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In various implementations, content services device(s) 530 may include a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 may receive content such as cable television programming including media information, digital information, and/or other content Examples of content providers may include any cable or satellite television or radio or Internet content providers. The provided examples are not meant to limit implementations in accordance with the present disclosure in any way.

In various implementations, platform 502 may receive control signals from navigation controller 550 having one or more navigation features. The navigation features of controller 550 may be used to interact with user interface 522, for example. In embodiments, navigation controller 550 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be replicated on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In embodiments, controller 550 may not be a separate component but may be integrated into platform 502 and/or display 520. The present disclosure, however, is not limited to the elements or in the context shown or described herein.

In various implementations, drivers (not shown) may include technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 even when the platform is turned “off.” In addition, chipset 505 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the present disclosure.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

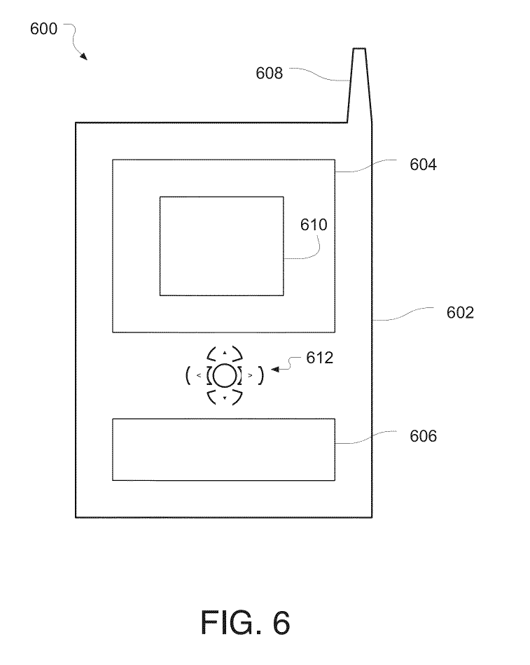

As described above, system 500 may be embodied in varying physical styles or form factors. FIG. 6 illustrates implementations of a small form factor device 600 in which system 500 may be embodied. In embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile interact device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may include a housing 602, a display 604, an input/output (I/O) device 606, and an antenna 608. Device 600 also may include navigation features 612. Display 604 may include any suitable display unit for displaying information appropriate for a mobile computing device. I/O device 606 may include any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one example, a computer-implemented method for selectively accentuating a focus area on a display of a computer may include reception of eye movement data of one or more users. Eye tracking may be performed for at least one of the one or more users. For example, the eye tracking may be performed based at least in part on the received eye movement data. A region of interest may be determined, where the region of interest may be associated with a portion of the display of the computer system. For example, the determination of the region of interest may be based at least in part on the performed eye tracking The focus area associated with the determined region of interest may be selectively accentuated. For example, the focus area may correspond with the portion of the display associated with the determined region of interest.

In some examples, the method may include determining whether an application has been designated for operation with eye tracking, where the performance of eye tracking occurs in response to the determination that the application has been designated for operation with eye tracking.

In some examples, the method may include selectively accentuating one or more subsequent focus areas, where the one or more subsequent focus areas corresponds with the portion of the display associated with one or more subsequent determined regions of interest.

In some examples, the method may include graphically illustrating a transition between e focus area and the one or more subsequent focus areas.

In some examples, the method may include recording the sequential selective accentuation of the focus area, the transition between the focus area and the one or more subsequent focus areas, and the selective accentuation of the one or more subsequent focus areas.

In some examples, the method may include removing the selective accentuation of the focus area in response to a determination that a current region of interest is located off of the display and/or when the focus area is not in focus anymore and a subsequent focus area has not been established.

In some examples, the method may operate so that the selective accentuation of the focus area includes one or more of the following accentuation techniques: zooming in on the focus area, out scaling the focus area, and highlighting the focus area; where the highlighting the focus area includes framing the focus area, re-coloring the focus area, and/or framing and re-coloring the focus area,

In some examples, the method may operate so that the selective accentuation of the focus area includes selectively accentuating the focus area based at least in part on a default area size and/or based at least in part on associating the region of interest with a discrete display element, where the discrete display element includes a text box, a paragraph of text, a default number of text lines, a picture, and/or a menu.

In other examples, a system for selective accentuation on a computer, may include a display, an imaging device, one or more processors, one or more memory stores, a data reception logic module, an eye tracking logic module, a region of interest logic module, a selective accentuation logic module, the like, and/or combinations thereof. The imaging device may be configured to capture eye movement data. The one or more processors may be communicatively coupled to the display and to the imaging device. The one or more memory stores may be communicatively coupled to the one or more processors. The data reception logic module may be communicatively coupled to the one or more processors and the one or more memory stores and may be configured to receive eye movement data of one or more users. The eye tracking logic module may be communicatively coupled to the one or more processors and the one or more memory stores and may be configured to perform eye tracking for at least one of the one or more users based at least in part on the received eye movement data. The region of interest logic module may be communicatively coupled to the one or more processors and the one or more memory stores and may be configured to determine a region of interest associated with a portion of the display based at least in part on the performed eye tracking. The selective accentuation logic module may be communicatively coupled to the one or more processors and the one or more memory stores and may be configured to selectively accentuate the focus area, where the focus area corresponds with the portion of the display associated with the determined region of interest.

In some examples, the system may operate so that the performance of eye tracking occurs in response to the determination that the application has been designated for operation with eye tracking. The selective accentuation of the focus area may include selectively accentuating one or more subsequent focus areas, where the one or more subsequent focus areas corresponds with the portion of the display associated with one or more subsequent determined regions of interest. The selective accentuation of the focus area may include graphically illustrating a transition between the focus area and the one or more subsequent focus areas. The selective accentuation of the focus area may include removing the selective accentuation of the focus area in response to a determination that a current region of interest is located off of the display and/or when the focus area is not in focus anymore and a subsequent focus area has not been established. The selective accentuation of the focus area may include one or more of the following accentuation techniques: zooming in on the focus area, out scaling the focus area, and highlighting the focus area; where the highlighting the focus area may include framing the focus area, re-coloring the focus area, and/or framing and re-coloring the focus area. The selective accentuation of the focus area may include selectively accentuating the focus area based at least in part on a default area size and/or based at least in part on associating the region of interest with a discrete display element. The discrete display element may include a text box, a paragraph of text, a default number of text lines, a picture, a menu, the like, and/or combinations thereof. In some examples, the system may include a recording logic module communicatively coupled to the one or more processors and the one or more memory stores and that may be configured to record the sequential selective accentuation of the focus area, the transition between the focus area and the one or more subsequent focus areas, and the selective accentuation of the one or more subsequent focus areas.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

1.-26. (canceled)

27. A computer-implemented method for selectively accentuating a focus area on a display of a computer, comprising:
receiving eye movement data of one or more users;
performing eye tracking for at least one of the one or more users based at least in part on the received eye movement data;
determining a region of interest associated with a portion of the display of the computer system based at least in part on the performed eye tracking; and
selectively accentuating the focus area, wherein the focus area corresponds with the portion of the display associated with the determined region of interest.

28. The method of claim 27, wherein the selective accentuation of the focus area comprises zooming in on the focus area.

29. The method of claim 27, wherein the selective accentuation of the focus area comprises out scaling the focus area.

30. The method of claim 27, wherein the selective accentuation of the focus area comprises highlighting the focus area, wherein the highlighting the focus area comprises framing the focus area, re-coloring the focus area, and/or framing and re-coloring the focus area.

31. The method of claim 27, wherein the selective accentuation of the focus area comprises selectively accentuating the focus area based at least in part on a default area size.

32. The method of claim 27, wherein the selective accentuation of the focus area comprises selectively accentuating the focus area based at least in part on associating the region of interest with a discrete display element, wherein the discrete display element comprises a text box, a paragraph of text, a default number of text lines, a picture, and/or a menu.

33. The method of claim 27, further comprising:
selectively accentuating one or more subsequent focus areas, wherein the one or more subsequent focus areas corresponds with the portion of the display associated with one or more subsequent determined regions of interest; and
graphically illustrating a transition between the focus area and the one or more subsequent focus areas.

34. The method of claim 27, further comprising:
selectively accentuating one or more subsequent focus areas, wherein the one or more subsequent focus areas corresponds with the portion of the display associated with one or more subsequent determined regions of interest; and
recording the sequential the selective accentuation of the focus area and the selective accentuation of the one or more subsequent focus areas.

35. The method of claim 27, further comprising:
selectively accentuating one or more subsequent focus areas, wherein the one or more subsequent focus areas corresponds with the portion of the display associated with one or more subsequent determined regions of interest;
graphically illustrating a transition between the focus area and the one or more subsequent focus areas; and
recording the sequential selective accentuation of the focus area, the transition between the focus area and the one or more subsequent focus areas, and the selective accentuation of the one or more subsequent focus areas.

36. The method of claim 27, further comprising:
removing the selective accentuation of the focus area in response to a determination that a current region of interest is located off of the display and/or when the focus area is not in focus anymore and a subsequent focus area has not been established.

37. The method of claim 27, further comprising:
determining whether an application has been designated for operation with eye tracking; and
wherein the performance of eye tracking occurs in response to the determination that the application has been designated for operation with eye tracking

38. The method of claim 27, further comprising:
determining whether an application has been designated for operation with eye tracking, wherein the performance of eye tracking occurs in response to the determination that the application has been designated for operation with eye tracking;
selectively accentuating one or more subsequent focus areas, wherein the one or more subsequent focus areas corresponds with the portion of the display associated with one or more subsequent determined regions of interest;
graphically illustrating a transition between the focus area and the one or more subsequent focus areas;
removing the selective accentuation of the focus area in response to a determination that a current region of interest is located off of the display and/or when the focus area is not in focus anymore and a subsequent focus area has not been established; and
recording the sequential selective accentuation of the focus area, the transition between the focus area and the one or more subsequent focus areas, and the selective accentuation of the one or more subsequent focus areas,
wherein the selective accentuation of the focus area comprises one or more of the following accentuation techniques: zooming in on the focus area, out scaling the focus area, and highlighting the focus area; wherein the highlighting the focus area comprises framing the focus area, re-coloring the focus area, and/or framing and re-coloring the focus area,
wherein the selective accentuation of the focus area comprises selectively accentuating the focus area based at least in part on a default area size and/or based at least in part on associating the region of interest with a discrete display element, wherein the discrete display element comprises a text box, a paragraph of text, a default number of text lines, a picture, and/or a menu.

39. A system for selective accentuation of a focus area of a computer display, comprising:
a display;
an imaging device configured to capture eye movement data;
one or more processors communicatively coupled to the display and to the imaging device;
one or more memory stores communicatively coupled to the one or more processors;
a data reception logic module communicatively coupled to the one or more processors and the one or more memory stores and configured to receive eye movement data of one or more users;
an eye tracking logic module communicatively coupled to the one or more processors and the one or more memory stores and configured to perform eye tracking for at least one of the one or more users based at least in part on the received eye movement data;
a region of interest logic module communicatively coupled to the one or more processors and the one or more memory stores and configured to determine a region of interest associated with a portion of the display based at least in part on the performed eye tracking; and
a selective accentuation logic module communicatively coupled to the one or more processors and the one or more memory stores and configured to selectively accentuate the focus area, wherein the focus area corresponds with the portion of the display associated with the determined region of interest.

40. The system of claim 39, wherein the selective accentuation of the focus area comprises zooming in on the focus area.

41. The system of claim 39, wherein the selective accentuation of the focus area comprises out scaling the focus area.

42. The system of claim 39, wherein the selective accentuation of the focus area comprises highlighting the focus area, wherein the highlighting the focus area comprises framing the focus area, re-coloring the focus area, and/or framing and re-coloring the focus area.

43. The system of claim 39, wherein the selective accentuation of the focus area comprises selectively accentuating the focus area based at least in part on a default area size.

44. The system of claim 39, wherein the selective accentuation of the focus area comprises selectively accentuating the focus area based at least in part on associating the region of interest with a discrete display element, wherein the discrete display element comprises a text box, a paragraph of text, a default number of text lines, a picture, and/or a menu.

45. The system of claim 39, wherein the selective accentuation logic module is further configured to selectively accentuate one or more subsequent focus areas, wherein the one or more subsequent focus areas corresponds with the portion of the display associated with one or more subsequent determined regions of interest, and graphically illustrate a transition between the focus area and the one or more subsequent focus areas.

46. The system of claim 39, wherein the selective accentuation logic module is further configured to selectively accentuate one or more subsequent focus areas, wherein the one or more subsequent focus areas corresponds with the portion of the display associated with one or more subsequent determined regions of interest; and
wherein the system further comprises a recording logic module communicatively coupled to the one or more processors and the one or more memory stores and configured to record the sequential the selective accentuation of the focus area and the selective accentuation of the one or more subsequent focus areas.

47. The system of claim 39, wherein the selective accentuation logic module is further configured to selectively accentuate one or more subsequent focus areas, wherein the one or more subsequent focus areas corresponds with the portion of the display associated with one or more subsequent determined regions of interest;
wherein the selective accentuation logic module is further configured to graphically illustrate a transition between the focus area and the one or more subsequent focus areas; and
wherein the system further comprises a recording logic module communicatively coupled to the one or more processors and the one or more memory stores and configured to record the sequential selective accentuation of the focus area, the transition between the focus area and the one or more subsequent focus areas, and the selective accentuation of the one or more subsequent focus areas.

48. The system of claim 39, wherein the selective accentuation logic module is further configured to remove the selective accentuation of the focus area in response to a determination that a current region of interest is located off of the display and/or when the focus area is not in focus anymore and a subsequent focus area has not been established.

49. The system of claim 39, further comprising:
wherein the performance of eye tracking occurs in response to the determination that the application has been designated for operation with eye tracking,
wherein the selective accentuation of the focus area comprises selectively accentuating one or more subsequent focus areas, wherein the one or more subsequent focus areas corresponds with the portion of the display associated with one or more subsequent determined regions of interest,
wherein the selective accentuation of the focus area comprises graphically illustrating a transition between the focus area and the one or more subsequent focus areas,
wherein the selective accentuation of the focus area comprises removing the selective accentuation of the focus area in response to a determination that a current region of interest is located off of the display and/or when the focus area is not in focus anymore and a subsequent focus area has not been established,
wherein the selective accentuation of the focus area comprises one or more of the following accentuation techniques: zooming in on the focus area, out scaling the focus area, and highlighting the focus area; wherein the highlighting the focus area comprises framing the focus area, re-coloring the focus area, and/or framing and re-coloring the focus area,
wherein the selective accentuation of the focus area comprises selectively accentuating the focus area based at least in part on a default area size and/or based at least in part on associating the region of interest with a discrete display element, wherein the discrete display element comprises a text box, a paragraph of text, a default number of text lines, a picture, and/or a menu, and
wherein the system further comprises a recording logic module communicatively coupled to the one or more processors and the one or more memory stores and configured to record the sequential selective accentuation of the focus area, the transition between the focus area and the one or more subsequent focus areas, and the selective accentuation of the one or more subsequent focus areas.

50. At least one machine readable medium comprising a plurality of instructions that in response to being executed on a computing device, cause the computing device to code data by:
receiving eye movement data of one or more users;
performing eye tracking for at least one of the one or more users based at least in part on the received eye movement data;
determining a region of interest associated with a portion of the display of the computer system based at least in part on the performed eye tracking; and
selectively accentuating the focus area, wherein the focus area corresponds with the portion of the display associated with the determined region of interest.

51. The machine readable medium of claim 50, further comprising instructions that in response to being executed on the computing device, cause the computing device to operate by:
determining whether an application has been designated for operation with eye tracking, wherein the performance of eye tracking occurs in response to the determination that the application has been designated for operation with eye tracking;
selectively accentuating one or more subsequent focus areas, wherein the one or more subsequent focus areas corresponds with the portion of the display associated with one or more subsequent determined regions of interest;
graphically illustrating a transition between the focus area and the one or more subsequent focus areas;
removing the selective accentuation of the focus area in response to a determination that a current region of interest is located off of the display and/or when the focus area is not in focus anymore and a subsequent focus area has not been established; and
recording the sequential selective accentuation of the focus area, the transition between the focus area and the one or more subsequent focus areas, and the selective accentuation of the one or more subsequent focus areas,
wherein the selective accentuation of the focus area comprises one or more of the following accentuation techniques: zooming in on the focus area, out scaling the focus area, and highlighting the focus area; wherein the highlighting the focus area comprises framing the focus area, re-coloring the focus area, and/or framing and re-coloring the focus area,
wherein the selective accentuation of the focus area comprises selectively accentuating the focus area based at least in part on a default area size and/or based at least in part on associating the region of interest with a discrete display element, wherein the discrete display element comprises a text box, a paragraph of text, a default number of text lines, a picture, and/or a menu.
